(19) United States
(12) Patent Application Publication
(10) Pub. No.: US 2023/0402217 A1
(43) Pub. Date: Dec. 14, 2023

(54) ELECTRONIC COMPONENT AND METHOD FOR MANUFACTURING ELECTRONIC COMPONENT

(71) Applicant: Murata Manufacturing Co., Ltd., Kyoto-fu (JP)

(72) Inventors: Isamu MIYAKE, Nagaokakyo-shi (JP); Hiromi TSUJI, Nagaokakyo-shi (JP); Mitsuru ODAHARA, Nagaokakyo-shi (JP)

(73) Assignee: Murata Manufacturing Co., Ltd., Kyoto-fu (JP)

(21) Appl. No.: 18/451,740

(22) Filed: Aug. 17, 2023

Related U.S. Application Data
(63) Continuation of application No. PCT/JP2022/003067, filed on Jan. 27, 2022.

(30) Foreign Application Priority Data
Feb. 26, 2021 (JP) 2021-030983

(51) Int. Cl. H01F 17/04; H01F 17/00; H01F 41/02

(52) U.S. Cl. CPC H01F 17/04; H01F 17/0006; H01F 41/0213

(57) ABSTRACT

An electronic component with improved characteristics includes an element body and an inductor wiring as a wiring line. The element body includes multiple flat plate-shaped magnetic thin strips made of a magnetic material of a sintered body. The multiple magnetic thin strips are laminated in a lamination direction orthogonal to a main face of one of the magnetic thin strips. The inductor wiring extends along the main face inside the element body.

### CROSS-REFERENCE TO RELATED APPLICATIONS

This application claims benefit of priority to International Patent Application No. PCT/JP2022/003067, filed Jan. 27, 2022, and to Japanese Patent Application No. 2021-030983, filed Feb. 26, 2021, the entire contents of each are incorporated herein by reference.

### BACKGROUND

### Technical Field

The present disclosure relates to an electronic component and a method for manufacturing the electronic component.

### Background Art

An inductor component being an electronic component described in Japanese Unexamined Patent Application Publication No. 2019-192920 includes an element body and a wiring line extending inside the element body. The element body is composed of an inorganic filler and resin. For example, in a magnetic composite body, a material of the inorganic filler is a magnetic material.

### SUMMARY

An inductor the electronic component described in Japanese Unexamined Patent Application Publication No. 2019-192920, various characteristics of the electronic component are improved by increasing a filling rate of an inorganic filler in an element body. However, when the composite body is formed by a build-up method as in the electronic component described in Japanese Unexamined Patent Application Publication No. 2019-192920, or when the composite body is formed by a molding method as in a composite body commonly used, stress is applied to the composite body during stamping or the like. Strain of the magnetic material due to the stress disturbs sufficient exhibition of characteristics of a magnetic material and reduces the degree of freedom in selecting the magnetic material.

Accordingly, an aspect of the present disclosure provides an electronic component, including an element body including multiple flat plate-shaped magnetic thin strips made of magnetic material of a sintered body, the multiple magnetic thin strips being laminated in a lamination direction orthogonal to a main face of one of the magnetic thin strips, and a wiring line extending along the main face inside the element body.

Also, an aspect of the present disclosure provides a method of manufacturing an electronic component, including forming a divided magnetic layer by forming a nonmagnetic layer using a nonmagnetic paste containing a nonmagnetic material, forming a magnetic layer on the nonmagnetic layer using a magnetic paste containing a magnetic material, dividing the magnetic layer by a groove, and filling the groove with a nonmagnetic paste containing a nonmagnetic material. The method also includes forming a multilayer body by arranging the divided magnetic layer above a wiring pattern formed by a conductive paste containing a conductive material; and firing the multilayer body to make the wiring pattern to a wiring line of a sintered body, to make the nonmagnetic layer to an interlayer nonmagnetic portion of a sintered body, and to make the magnetic layer to a magnetic thin strip of a sintered body.

With the use of the electronic component described above, an element body includes a magnetic thin strip made of a magnetic material of a sintered body. By adopting a sintered body as a magnetic thin strip, the strain of the magnetic thin strip may be reduced in a sintering process. As a result, the characteristics of the electronic component may be improved.

Note that a term “being along” includes a case not being in direct contact with and in a separated position. For example, “being along a first axis” includes not only “being along the first axis and in direct contact with the first axis” but also “being along the first axis not in direct contact with and in a separated position from the first axis”. Further, the term “being along” only needs being substantially parallel to each other and includes being slightly inclined due to manufacturing error or the like.

In an electronic component in which multiple magnetic thin strips are laminated, characteristics may be improved.

### BRIEF DESCRIPTION OF THE DRAWINGS

FIG. 1 is an exploded perspective view of an inductor component according to a first embodiment;

FIG. 2 is a plan view of a first portion of the inductor component;

FIG. 3 is a sectional view of the inductor component taken along a line 3-3 in FIG. 2;

FIG. 4 is an enlarged sectional view of a magnetic thin strip in Example 1;

FIG. 5 is an enlarged sectional view of a magnetic thin strip in Example 2;

FIG. 6 is a graph illustrating inductance with respect to a current of an inductor component of Comparative Example and inductor component of Examples;

FIG. 7 is a table of respective parameters of the inductor component of Comparative Example and the inductor component of Examples;

FIG. 8 is a sectional view of an inductor component according to a second embodiment;

FIG. 9 is an explanatory view of a method for manufacturing an inductor component;

FIG. 10 is an explanatory view of the method for manufacturing the inductor component;

FIG. 11 is an explanatory view of the method for manufacturing the inductor component;

FIG. 12 is an explanatory view of the method for manufacturing the inductor component;

FIG. 13 is an explanatory view of the method for manufacturing the inductor component;

FIG. 14 is an explanatory view of the method for manufacturing the inductor component;

FIG. 15 is an explanatory view of the method for manufacturing the inductor component;

FIG. 16 is an explanatory view of the method for manufacturing the inductor component;

FIG. 17 is an explanatory view of the method for manufacturing the inductor component;

FIG. 18 is an explanatory view of the method for manufacturing the inductor component; and

FIG. 19 is a sectional view of an inductor component according to a modification.

### DETAILED DESCRIPTION

### First Embodiment

Hereinafter, a first embodiment of an inductor component will be described as an example of an electronic component. Note that, in the drawings, constituents may be enlarged to facilitate understanding. Dimensional ratios of the constituents may be different from actual ones or from those in other figures. Further, hatching is applied to a sectional view, but hatching of some constituents may be omitted to facilitate understanding. Furthermore, among multiple members, only some members may be denoted by reference signs.

(Overall Configuration)

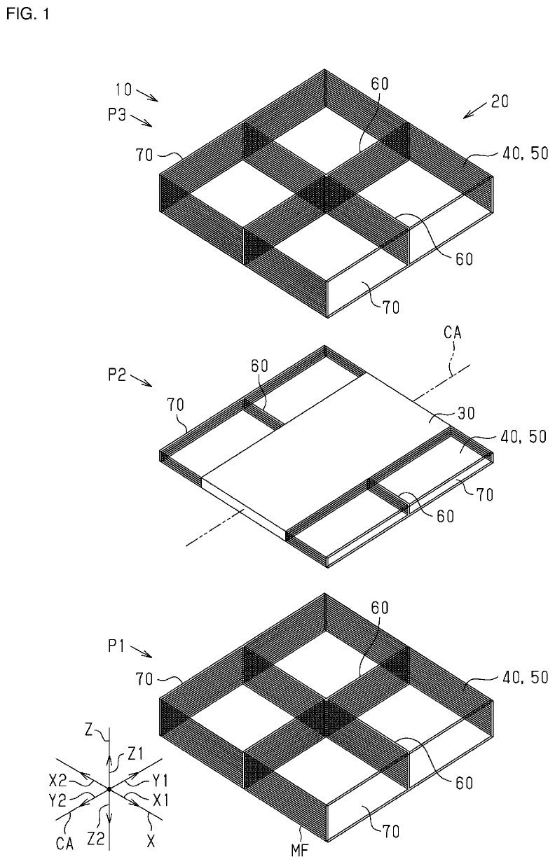

An inductor component 10 includes an element body 20 and an inductor wiring 30 as illustrated in FIG. 1. The element body 20 includes multiple magnetic thin strips 40, multiple interlayer nonmagnetic portions 50, multiple nonmagnetic portions 60, and multiple nonmagnetic films 70.

The magnetic thin strip 40 has a flat plate-shape. The multiple magnetic thin strips 40 are laminated in a lamination direction being a direction orthogonal to a main face MF of the magnetic thin strip 40. Note that the term “flat plate-shape” refers to a thin shape having the main face MF, but is not limited to a thin rectangular parallelepiped, and may have curved edges or corners, may have minute irregularities on the main face MF, or may have pores inside.

The inductor wiring 30 linearly extends along the main face MF inside the element body 20. An axis along which the inductor wiring 30 extends is referred to as a center axis CA. In the present embodiment, a direction in which the center axis CA extends coincides with a direction in which any one side of the quadrangular main face MF extends.

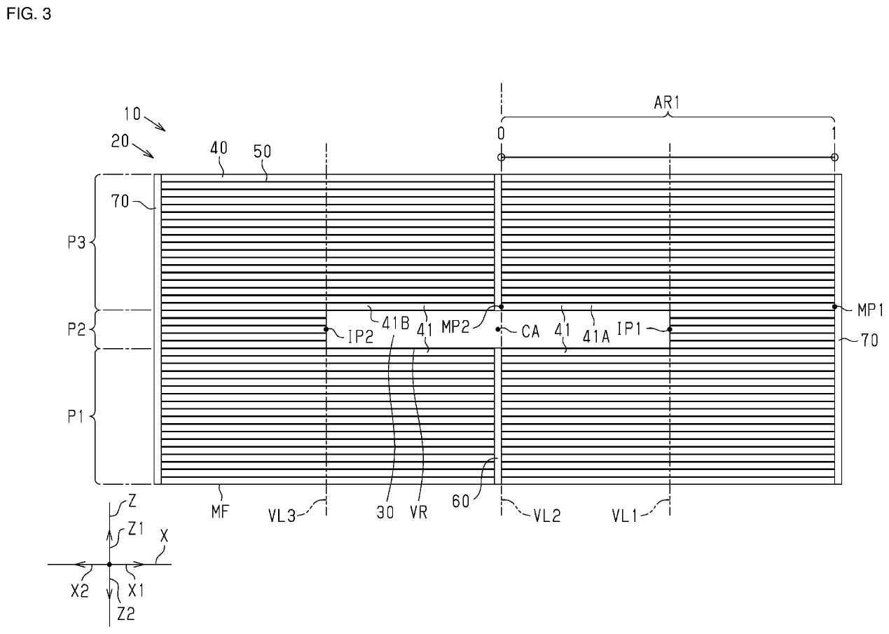

In a sectional view orthogonal to the center axis CA, an axis along the main face MF is defined as a first axis X, and an axis orthogonal to the main face MF is defined as a second axis Z as illustrated in FIG. 3. One direction along the first axis X is defined as a first positive direction X1, and the other direction along the first axis X is defined as a first negative direction X2. One direction along the center axis CA is defined as a positive direction Y1, and the other direction along the center axis CA is defined as a negative direction Y2. Further, one direction along the second axis Z is defined as a second positive direction Z1, and the other direction along the second axis Z is defined as a second negative direction Z2. In the present embodiment, the lamination direction coincides with the direction along the second axis Z.

The inductor component 10 is constituted of a first portion P1, a second portion P2, and a third portion P3 laminated in this order along the second axis Z as illustrated in FIG. 1. Among the three portions P1 to P3, the first portion P1 is positioned at an end in the second negative direction Z2 along the second axis Z.

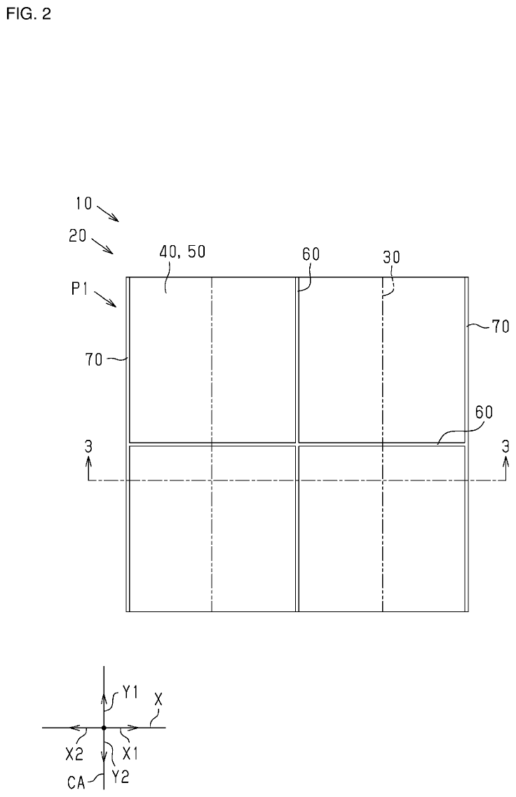

The first portion P1 has a square shape in a view from the direction along the second axis Z as illustrated in FIG. 2. The first portion P1 includes the multiple magnetic thin strips 40, the multiple interlayer nonmagnetic portions 50, the multiple nonmagnetic portions 60, and the multiple nonmagnetic films 70.

In a sectional view orthogonal to the center axis CA, the magnetic thin strips of the first portion P1 are laminated in the direction along the second axis Z as illustrated in FIG. 3. Each of the magnetic thin strips 40 of the first portion P1 has a square shape in a view from the direction along the second axis Z as illustrated in FIG. 2. In a view from the direction along the second axis Z, each side of each magnetic thin strip 40 is parallel to the first axis X or the center axis CA. All measurements of the multiple magnetic thin strips 40 in the direction along the second axis Z are the same.

Two magnetic thin strips 40 are arranged side by side at the same position along the second axis Z with an interval therebetween in a direction along a first reference axis orthogonal to the second axis Z. Further, two magnetic thin strips 40 are arranged side by side at the same position along the second axis Z with an interval therebetween in a direction along a second reference axis orthogonal to the second axis Z and the first reference axis. Note that, in the present embodiment, the first reference axis coincides with the center axis CA, and the second reference axis coincides with the first axis X.

The magnetic thin strip 40 has a flat plate-shape and is made of a magnetic material of a sintered body. The magnetic thin strip 40 contains at least one of Fe, Ni, an alloy containing an Fe element and an Si element, an alloy containing the Fe element and an Ni element, and an alloy containing the Fe element and a Co element. In the present embodiment, the magnetic thin strip 40 is a magnetic metal material containing an alloy containing the Fe element and the Ni element. Note that Fe is metal iron and Ni is metal nickel.

The interlayer nonmagnetic portion 50 is positioned between the magnetic thin strips 40 adjacent to each other in the direction along the second axis Z as illustrated in FIG. 3. The magnetic thin strips 40 and the interlayer nonmagnetic portions 50 are alternately laminated, and in the present embodiment, the interlayer nonmagnetic portions 50 fill all the spaces between the magnetic thin strips 40 adjacent to each other in the direction along the second axis Z. The interlayer nonmagnetic portion 50 is made of a nonmagnetic material of a sintered body. The nonmagnetic material is alumina, silica, crystallized glass, or amorphous glass, for example. Note that the interlayer nonmagnetic portion 50 is indicated by a line in FIG. 3.

All measurements of the interlayer nonmagnetic portions 50 in the direction along the second axis Z are the same. The measurement of each interlayer nonmagnetic portion 50 in the direction along the second axis Z is smaller than the measurement of each magnetic thin strip 40 in the direction along the second axis Z.

The nonmagnetic portion 60 is positioned between the magnetic thin strips 40 arranged side by side at the same position along the second axis Z as illustrated in FIG. 2. The nonmagnetic portion 60 fills all the spaces between the magnetic thin strips 40 arranged at the same position in the direction along the second axis Z. As described above, at the same position along the second axis Z, there are four magnetic thin strips 40 in total including two in the direction along the center axis CA and two in the direction along the first axis X, and thus there are four nonmagnetic portions 60. The nonmagnetic portion 60 is made of a nonmagnetic material. In the present embodiment, a material of the nonmagnetic portion 60 is the same material as that of the interlayer nonmagnetic portion 50. In other words, the nonmagnetic portion 60 is made of a nonmagnetic material of a sintered body.

In the first portion P1, the nonmagnetic films 70 are positioned at an end in the first positive direction X1 along the first axis X, and at an end in the first negative direction X2 being an opposite direction of the first positive direction X1. The nonmagnetic films 70 cover the entire region of both end faces of the magnetic thin strips in the direction along the first axis X. Further, the nonmagnetic films 70 cover the entire region of both end faces of the interlayer nonmagnetic portions 50 in the direction along the first axis X. Furthermore, the nonmagnetic films 70 cover the entire region of both end faces of the nonmagnetic portions 60 in the direction along the first axis X. Therefore, the entire end face of the first portion P1 in the first positive direction X1 along the first axis X is formed by the nonmagnetic film 70. In the same manner, the entire end face of the first portion P1 in the first negative direction X2 along the first axis X is formed by the nonmagnetic film 70. The nonmagnetic film 70 is made of a nonmagnetic material. In the present embodiment, a material of the nonmagnetic film 70 is the same material as that of the interlayer nonmagnetic portion 50.

In a view from the first portion P1, the second portion P2 is positioned in the second positive direction Z1 along the second axis Z as illustrated in FIG. 1. The second portion P2 has the same square shape as that of the first portion P1 in a view from the direction along the second axis Z.

The second portion P2 is constituted of the inductor wiring 30, the multiple magnetic thin strips 40, the multiple interlayer nonmagnetic portions 50, the multiple nonmagnetic portions 60, and the multiple nonmagnetic films 70.

The inductor wiring 30 has a rectangular shape in a view from the direction along the second axis Z, and extends linearly along the center axis CA. An end face of the inductor wiring 30 in the positive direction Y1 along the center axis CA constitutes part of an outer face of the second portion P2 and is exposed from the element body 20. In the same manner, an end face of the inductor wiring 30 in the negative direction Y2 being an opposite direction of the positive direction Y1 along the center axis CA constitutes part of the outer face of the second portion P2 and is exposed from the element body 20.

In a view from the second axis Z, the end face of the inductor wiring 30 in the positive direction Y1 and the end face of the inductor wiring 30 in the negative direction Y2 are parallel to the first axis X. Further, the center axis CA of the inductor wiring 30 is positioned at a center of the second portion P2 in the direction along the first axis X. Therefore, the center axis CA along which the inductor wiring 30 extends passes through the center of the second portion P2 in the direction along the first axis X. A measurement of the inductor wiring 30 in the direction along the first axis X is half the measurement of the second portion P2 in the direction along the first axis X.

A material of the inductor wiring 30 is a conductive material. The conductive material is Cu, Ag, Au, Al, or an alloy containing any of these elements, for example. In the present embodiment, the material of the inductor wiring 30 is Cu.

The inductor wiring 30 has a rectangular shape in a section orthogonal to the center axis CA as illustrated in FIG. 3. Here, in the section orthogonal to the center axis CA, drawn is a virtual rectangle VR with the minimum area, circumscribing the inductor wiring 30, and having a first side along the first axis X and a second side along the second axis Z. In the present embodiment, the inductor wiring 30 has a rectangular shape in the section orthogonal to the center axis CA. Further, in the section orthogonal to the center axis CA, a long side of an outer shape of the inductor wiring 30 extends along the first axis X. Furthermore, in the section orthogonal to the center axis CA, a short side of the outer shape of the inductor wiring 30 extends along the second axis Z. Therefore, the virtual rectangle VR coincides with the outer shape of the inductor wiring 30. The first side of the virtual rectangle VR is longer than the second side of the virtual rectangle VR.

A portion of the second portion P2 other than the inductor wiring 30 is constituted of the multiple magnetic thin strips 40, the multiple interlayer nonmagnetic portions 50, the multiple nonmagnetic portions 60, and the multiple nonmagnetic films 70, as in the same manner as the first portion P1.

In a sectional view orthogonal to the center axis CA, the magnetic thin strips 40 of the second portion P2 are laminated in the direction along the second axis Z as illustrated in FIG. 3. Each of the magnetic thin strips 40 of the second portion P2 has a rectangular shape in a view from the direction along the second axis Z as illustrated in FIG. 2. In a view from the direction along the second axis Z, a long side of each magnetic thin strip 40 is parallel to the center axis CA. All measurements of the multiple magnetic thin strips 40 in the direction along the second axis Z are the same.

In the second portion P2, the magnetic thin strips 40 are positioned on both sides of the first positive direction X1 and the first negative direction X2 along the first axis X in a view from the inductor wiring 30 as illustrated in FIG. 1. That is, in the second portion P2, two magnetic thin strips 40 are arranged in the direction along the first axis X sandwiching the inductor wiring 30. Further, two magnetic thin strips 40 are arranged side by side at the same position along the second axis Z in the direction along the center axis CA with an interval therebetween.

In the same manner as the first portion P1 described above, the interlayer nonmagnetic portion 50 of the second portion P2 is positioned between the magnetic thin strips 40 adjacent to each other in the direction along the second axis Z. That is, in the same manner as the first portion P1, the magnetic thin strips 40 and the interlayer nonmagnetic portions 50 are alternately laminated in the direction along the second axis Z as illustrated in FIG. 3.

The nonmagnetic portion 60 of the second portion P2 is positioned between the magnetic thin strips 40 arranged at the same position along the second axis Z. The nonmagnetic portion 60 fills all the spaces between the magnetic thin strips 40 arranged at the same position in the direction along the second axis Z. A position of the nonmagnetic portion 60 of the second portion P2 overlaps with part of the nonmagnetic portion 60 of the first portion P1 in a view from the direction along the second axis Z. The nonmagnetic portion 60 of the second portion P2 is continuous to the nonmagnetic portion 60 of the first portion P1. Note that, in the second portion P2, no nonmagnetic portion 60 is present between the inductor wiring 30 and the magnetic thin strip 40.

In the second portion P2, the nonmagnetic film 70 is positioned at an end in the first positive direction X1 along the first axis X, and at an end in the first negative direction X2 being the opposite direction of the first positive direction X1. The nonmagnetic film 70 of the second portion P2 is continuous to the nonmagnetic film 70 of the first portion P1.

The third portion P3 is positioned in the second positive direction Z1 of the second portion P2. The third portion P3 has the same square shape as that of the first portion P1 in a view from the second axis Z. The third portion P3 is constituted of the multiple magnetic thin strips 40, the multiple interlayer nonmagnetic portions 50, the multiple nonmagnetic portions 60, and the multiple nonmagnetic films 70. In the present embodiment, since the third portion P3 has a structure symmetrical to the first portion P1 with the second portion P2 interposed therebetween, a detailed description thereof will be omitted. As described above, the element body 20 includes multiple magnetic thin strips multiple interlayer nonmagnetic portions 50, multiple nonmagnetic portions 60, and multiple nonmagnetic films 70.

(First Magnetic Thin Strip)

Among the multiple magnetic thin strips 40, the magnetic thin strip 40 closest to the inductor wiring 30 in the lamination direction, that is, the direction along the second axis Z is defined as a first magnetic thin strip 41 as illustrated in FIG. 3. In the present embodiment, the first magnetic thin strip 41 is the magnetic thin strip 40 positioned furthest in the second positive direction Z1 among the magnetic thin strips 40 in the first portion P1 and is the magnetic thin strip 40 positioned furthest in the second negative direction Z2 among the magnetic thin strips 40 in the third portion P3. That is, the first magnetic thin strip 41 being the magnetic thin strip 40 closest to the inductor wiring 30 is not arranged in the same layer as the inductor wiring 30. Therefore, the magnetic thin strip 40 positioned in the second portion P2 is not the first magnetic thin strip 41.

Among the multiple magnetic thin strips 40, two magnetic thin strips 40 are arranged side by side in the direction along the first reference axis, that is, the center axis CA, and two magnetic thin strips 40 are arranged side by side in the direction along the second reference axis, that is, the first axis X, at the same position as that of the first magnetic thin strip 41 in the lamination direction, that is, the direction along the second axis Z.

Further, among the multiple magnetic thin strips 40, at the position of the magnetic thin strips 40 laminated in the direction along the second axis Z of the first magnetic thin strip 41 of the first portion P1, two magnetic thin strips 40 are arranged side by side in the direction along the center axis CA, and two magnetic thin strips 40 are arranged side by side in the direction along the first axis X. As described above, as far as the multiple magnetic thin strips 40 of the first portion P1, two magnetic thin strips 40 are arranged side by side in the direction along the center axis CA, and two magnetic thin strips 40 are arranged side by side in the direction along the first axis X at each position in the direction along the second axis Z.

In the same manner, as far as the multiple magnetic thin strips 40 of the third portion P3, two magnetic thin strips 40 are arranged side by side in the direction along the center axis CA, and two magnetic thin strips 40 are arranged side by side in the direction along the first axis X at each position in the direction along the second axis Z. As described above, the multiple magnetic thin strips 40 in the element body 20 are regularly arranged in the direction along the center axis CA, in the direction along the first axis X, and in the direction along the second axis Z.

(Second Magnetic Thin Strip)

In a sectional view orthogonal to the center axis CA, an end of the inductor wiring 30 in the first positive direction X1 is defined as a first wiring end IP1 as illustrated in FIG. 3. Further, in a sectional view orthogonal to the center axis CA, an end of the inductor wiring 30 in the first negative direction X2 is defined as a second wiring end IP2.

Among the magnetic thin strips 40 laminated in the direction along the second axis Z relative to the inductor wiring 30, the magnetic thin strip 40 having the shortest distance from the first wiring end IP1 along the second axis Z is defined as a second magnetic thin strip 41A. Note that, in a view from the direction along the second axis Z, the magnetic thin strip 40 at least part of which overlaps with the inductor wiring 30 is the magnetic thin strip 40 laminated in the direction along the second axis Z relative to the inductor wiring 30. Therefore, in the present embodiment, the magnetic thin strip 40 in the first portion P1 and the magnetic thin strip 40 in the third portion P3 are the magnetic thin strips 40 laminated in the direction along the second axis Z relative to the inductor wiring 30. On the other hand, the magnetic thin strip 40 in the second portion P2 is not laminated in the direction along the second axis Z relative to the inductor wiring 30. Further, in the present embodiment, the second magnetic thin strip 41A is, among the first magnetic thin strips 41, the magnetic thin strip 40 laminated in a direction along the second axis Z of the first wiring end IP1. Therefore, the second magnetic thin strip 41A is the magnetic thin strip 40 positioned furthest in the second positive direction Z1 among the magnetic thin strips 40 in the first portion P1, and the magnetic thin strip 40 positioned furthest in the second negative direction Z2 among the magnetic thin strips 40 in the third portion P3.

In one magnetic thin strip 40, an end in the first positive direction X1 is defined as a first end MP1, and an end in the first negative direction X2 is defined as a second end MP2 as illustrated in FIG. 3. At this time, a range excluding both ends in the direction along the first axis X in one magnetic thin strip 40 is defined as a first range AR1. In other words, in one magnetic thin strip 40, a coordinate indicating the position of the second end MP2 in the direction along the first axis X is defined as 0. In one magnetic thin strip 40, a coordinate indicating a position of the first end MP1 along the first axis X, in the first positive direction X1 along the first axis X is defined as 1. At this time, a range in which a coordinate indicating the position in the direction along the first axis X is larger than 0 and smaller than 1 is the first range AR1. Then, a first virtual straight line VL1 is drawn in a direction passing through the first wiring end IP1 and extending along the second axis Z as illustrated in FIG. 3. At this time, the first virtual straight line VL1 passes through the first range AR1 of the second magnetic thin strip 41A.

Further, according to the present embodiment, in the first portion P1, the multiple magnetic thin strips 40 are continuously laminated in the second negative direction Z2 relative to the inductor wiring 30. Then, in a sectional view orthogonal to the center axis CA, the first virtual straight line VL1 passes through the first range AR1 of two or more magnetic thin strips 40 continuously laminated including the second magnetic thin strip 41A, among the multiple magnetic thin strips 40 continuously laminated from the second magnetic thin strip 41A in the second negative direction Z2. Specifically, the first virtual straight line VL1 passes through the first range AR1 of all the magnetic thin strips 40 continuously laminated to the second magnetic thin strip 41A, among the magnetic thin strips 40 included in the first portion P1.

Furthermore, in the third portion P3, the multiple magnetic thin strips 40 are continuously laminated in the second positive direction Z1 relative to the inductor wiring 30. Then, in a sectional view orthogonal to the center axis CA, the first virtual straight line VL1 passes through the first range AR1 of two or more magnetic thin strips 40 continuously laminated including the second magnetic thin strip 41A, among the multiple magnetic thin strips 40 continuously laminated from the second magnetic thin strip 41A in the second positive direction Z1. Specifically, the first virtual straight line VL1 passes through the first range AR1 of all the magnetic thin strips 40 continuously laminated to the second magnetic thin strip 41A, among the magnetic thin strips 40 included in the third portion P3.

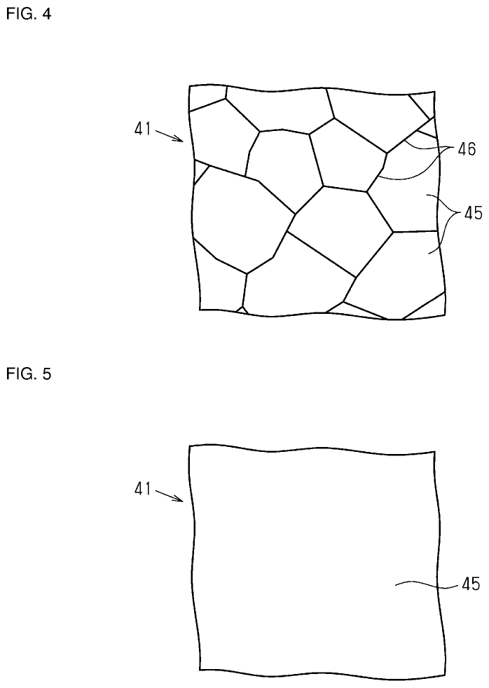

All of the magnetic thin strips 40 are sintered bodies. In the present embodiment, as described above, the magnetic material contains the Fe element and the Ni element. Specifically, in Example 1 illustrated in FIG. 4, the magnetic thin strip 40 includes multiple magnetic metal bodies 45, for example. Specifically, in Example 1, the magnetic metal body 45 is a magnetic metal particle of an alloy containing the Fe element and a Ni element. At a grain boundary between the magnetic metal bodies 45, an insulative substance 46, which is an oxide containing an O element, is present. As in Example 2 illustrated in FIG. 5, in the magnetic thin strip 40, the alloy containing the Fe element and the Ni element may completely be solid-solved and integrated. In the case above, the magnetic metal body 45 of the alloy containing the Fe element and the Ni element does not have a structure in which multiple magnetic metal particles are bonded to each other with a clear interface as illustrated in FIG. 4.

Drawn is a second virtual straight line VL2 passing through a second end MP2 of the second magnetic thin strip 41A in the first negative direction X2 being an opposite direction of the first positive direction X1 along the first axis X, and extending in the direction along the second axis Z. At this time, the second virtual straight line VL2 passes through the inductor wiring 30. In the present embodiment, the second virtual straight line VL2 is positioned substantially at a center of the inductor wiring 30 in the direction along the first axis X.

Note that, in the present embodiment, the inductor component 10 has a structure of reflection symmetry with the second axis Z, passing through a center in the direction along the first axis X, as a symmetry axis. Here, drawn is a third virtual straight line VL3 passing through the second wiring end IP2 of the inductor wiring 30, and extending in the direction along the second axis Z. Further, among the magnetic thin strips 40 laminated in the direction along the second axis Z relative to the inductor wiring 30, the magnetic thin strip 40 having the shortest distance from the second wiring end IP2 along the second axis Z is defined as a third magnetic thin strip 41B. In the case above, the third virtual straight line VL3 passes through the first range AR1 of the third magnetic thin strip 41B in a sectional view orthogonal to the center axis CA. More specifically, the third virtual straight line VL3 passes through a center of the third magnetic thin strip 41B in the direction along the first axis X.

Further, in the present embodiment, in a sectional view orthogonal to the center axis CA, the third virtual straight line VL3 passes through the first range AR1 of two or more magnetic thin strips 40 continuously laminated including the third magnetic thin strip 41B. Specifically, the third virtual straight line VL3 passes through the first range AR1 of all the magnetic thin strips 40 continuously laminated to the third magnetic thin strip 41B, among the magnetic thin strips 40 included in the first portion P1.

Furthermore, the third virtual straight line VL3 passes through the first range AR1 of all the magnetic thin strips 40 continuously laminated to the third magnetic thin strip 41B, among the magnetic thin strips 40 included in the third portion P3. More specifically, the third virtual straight line VL3 passes through centers of all the magnetic thin strips 40 continuously laminated to the third magnetic thin strip 41B. As described above, in a sectional view orthogonal to the center axis CA, it is preferable that the third virtual straight line VL3 pass through the first range AR1 of the third magnetic thin strip 41B.

(Simulation Results)

Next, simulation results comparing characteristics obtained for the inductor component 10 with those obtained for an inductor component of Comparative Example will be described. For the simulation, Femtet (registered trademark) of Murata Software Co., Ltd. was used.

First, conditions of the simulation will be described.

The software used is Femtet2019 developed by Murata Software Co., Ltd. Static magnetic field analysis is used for the solver. A three dimensional model is used. The standard mesh size is 0.01 mm. The magnetic body is a magnetic metal thin strip composed of the Fe element and the Ni element. A magnetic body BH curve satisfying B=Bs×tan h(μ0×μr×H/Bs) was used. A portion having a relative permeability μr of 1 or more in the magnetic body BH curve was used so that the permeability of vacuum was at least equal or exceeded. Further, the function of Femtet2019 is used to extrapolate the permeability of vacuum. The material of the inductor wiring 30 is copper.

Next, conditions regarding the size and position of the inductor component model used in the simulation will be described.

A measurement of the inductor wiring 30 in the direction along the first axis X is 500 μm. A measurement of the inductor wiring 30 in the direction along the second axis Z is 100 μm. A measurement of the inductor wiring 30 in the direction along the center axis CA is 2400 μm.

A measurement of the magnetic thin strip 40 in the direction along the first axis X is 990 μm. A measurement of the magnetic thin strip 40 in the direction along the second axis Z is 20 μm. A measurement of the magnetic thin strip 40 in the direction along the center axis CA is 990 μm.

A measurement of the interlayer nonmagnetic portion 50 in the direction along the second axis Z is 2.0 μm. A measurement of the nonmagnetic portion 60 in the direction along the first axis X is 20 μm. A measurement of the nonmagnetic portion 60 in the direction along the center axis CA is 20 μm. The number of the magnetic thin strips 40 laminated in the direction along the second axis Z is 41. The number of the magnetic thin strips 40 arranged side by side in the direction along the first axis X is two. The number of the magnetic thin strips 40 arranged side by side in the direction along the center axis CA is two.

A measurement of the inductor component 10 in the direction along the second axis Z is 902 μm. In the simulation, the element body 20 has films made of the same nonmagnetic material as that of the nonmagnetic film 70 at both ends in the direction along the center axis CA. A measurement of the film in the direction along the center axis CA is 10 μm. Therefore, a measurement of the inductor component 10 in the direction along the first axis X is 2020 μm. A measurement of the element body 20 in the direction along the center axis CA is 2020 μm. That is, in the simulation, the measurement of the inductor wiring 30 in the direction along the center axis CA is larger than the measurement of the element body 20 in the direction along the center axis CA by 380 μm. Therefore, the simulation is performed in a state that the inductor wiring 30 protrudes from an end face of the element body 20 in the positive direction Y1 by 190 μm and protrudes from an end face of the element body 20 in the negative direction Y2 by 190 μm.

A measurement of the inductor wiring 30 in the direction along the second axis Z is 100 μm. The inductor wiring 30 was arranged such that the gravity center of the inductor wiring 30 coincided with the gravity center position of the element body 20. The relative permeability μr of the nonmagnetic material of the interlayer nonmagnetic portion 50, the nonmagnetic portion 60, and the nonmagnetic film 70 was set to 1.

In the magnetic thin strip 40 of Example 1 of the simulation, the magnetic metal bodies 45 of an Fe—Ni alloy were not solid-solved with each other and were in contact with each other via grain boundaries, as illustrated in FIG. 4. In Example 1, relative permeability μr is 500, and saturation magnetic flux density Bs is 1.3[T].

In the magnetic thin strip 40 of Example 2 of the simulation, the magnetic metal bodies 45 of the Fe—Ni alloy were in a bulk state in which the magnetic metal particles of the precursor thereof were solid-solved with each other and were sintered to be integrated, as illustrated in FIG. 5. In Example 2, relative permeability μr is 7000, and saturation magnetic flux density Bs is 1.3[T]. Therefore, the relative permeability μr in Example 2 is extremely larger than the relative permeability μr in Example 1.

Further, in the simulation, the element body 20 in Comparative Example was in a state in which a metal composite material of powdery magnetic metal particles made of the Fe—Ni alloy and an organic resin was contained at a filling rate of 70%. Therefore, in Comparative Example, relative permeability μr is 24, and saturation magnetic flux density Bs is 0.91[T].

Next, characteristic indices calculated by the simulation will be described.

The unit of inductance L is [nH], and the unit of a DC superposition characteristic Isat is [A]. The DC superposition characteristic Isat is a current value Idc when the inductance L decreases by 20% relative to an initial inductance Lin which is the inductance L at a current value Idc of 0.001 [A].

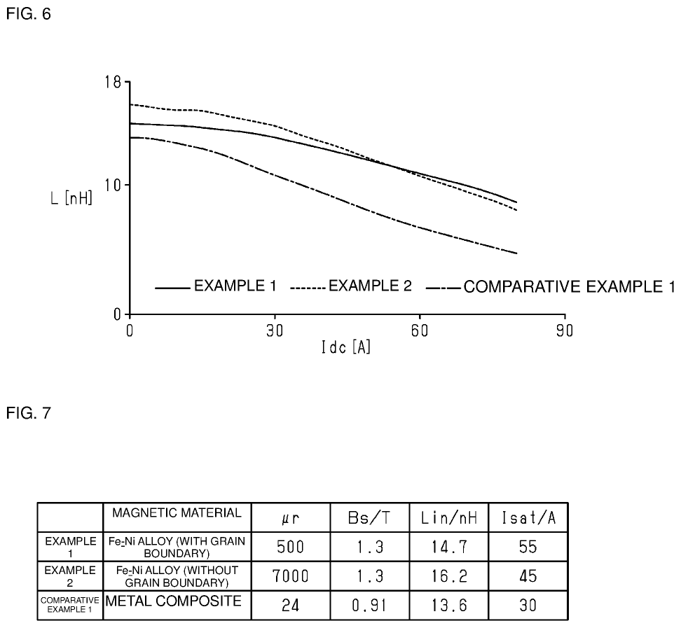

With Example 1, Example 2, and Comparative Example, the inductance L obtained by changing the current value Idc within the range of 0.001 [A] to 80 [A] was calculated by simulation as illustrated in FIG. 6.

The initial inductance Lin in Example 1 was 14.7 [nH], and the initial inductance Lin in Example 2 was 16.2 [nH] as illustrated in FIG. 7. On the other hand, the initial inductance Lin in Comparative Example was 13.6 [nH]. Therefore, the initial inductance Lin in Example was larger than the initial inductance Lin in Comparative Example.

The DC superposition characteristic Isat in Example 1 was 55 [A], and the DC superposition characteristic Isat in Example 2 was 45 [A]. On the other hand, the DC superposition characteristic Isat in Comparative Example was 30 [A]. Therefore, the DC superposition characteristic Isat obtained in Example was larger than the DC superposition characteristic Isat obtained in Comparative Example.

### Actions of First Embodiment

Next, actions of the first embodiment will be described.

In the first embodiment, the magnetic thin strip 40 is made of a magnetic material of a sintered body. In the sintered body, the magnetic metal particles are more densely aggregated than in a powder state. Therefore, the amount of the magnetic metal particles contained per unit volume increases as compared with that before sintering. As a result, high effective permeability may be obtained as the entire element body 20.

The magnetic metal body 45 included in the magnetic thin strip 40 may have strain before sintering. Even when the magnetic metal body 45 has strain, such strain is eliminated by firing the magnetic metal body 45 in a sintering process. Note that an oxide layer may be formed on a surface of the magnetic metal body 45 during a pre-sintering process or the sintering process. The oxide layer becomes the insulative substance 46 containing the Oxygen element after sintering. Note that the “strain in the magnetic thin strip 40” is not limited to a visible strain but includes micro strain in a crystal structure or an intermolecular structure or the like.

(Effects of First Embodiment)

Next, effects of the first embodiment will be described.
(1-1) According to the first embodiment, the magnetic thin strip 40 is a sintered body. By adopting a sintered body as the magnetic thin strip 40, the strain of the magnetic thin strip 40 may be reduced in the sintering process. As a result, the deterioration of magnetic characteristics of the magnetic thin strip 40 such as permeability and coercive field strength in the manufacturing process may be suppressed.

Therefore, crystalline magnetic metal particles having a large magnetostriction constant but having high saturation magnetic flux density Bs may be employed, and high saturation magnetic flux density Bs may be obtained in the entire element body 20. As a result, both the initial inductance Lin and the DC superposition characteristic Isat, which are the characteristic indices, become larger than in a case that the entire element body 20 is a metal composite material of powdery magnetic metal particles and an organic resin. Therefore, according to the first embodiment, the characteristics of the inductor component 10 may be improved.
(1-2) According to the first embodiment, the magnetic thin strip 40, which is a sintered body, contains an alloy containing the Fe element and the Ni element. The alloy containing the Fe element and the Ni element may obtain high permeability u. Therefore, the initial inductance Lin and the DC superposition characteristic Isat, which are characteristic indices, may be obtained in large values.
(1-3) According to the first embodiment, in the magnetic thin strip 40, the magnetic metal bodies 45, which are multiple magnetic metal particles, are coupled to each other via the insulative substance 46 having an insulation property. Therefore, eddy current loss due to a conductive path in which the magnetic metal bodies 45 are connected to each other may be reduced, and a leakage current and a short circuit may be suppressed due to the same reason.
(1-4) According to the first embodiment, the insulative substance 46 contains the Oxygen element. That is, the insulative substance 46 is an oxide. Therefore, the insulative substance 46 may be formed by oxidizing the grain boundaries of the multiple magnetic metal particles during the pre-sintering process or the sintering process. Thus, it is not necessary to use a material different from the precursor constituting the magnetic metal body 45 to provide the insulative substance 46.
(1-5) According to the first embodiment, the first virtual straight line VL1 passes through the first range AR1 of the second magnetic thin strip 41A. Therefore, in magnetic flux generated when a current flows through the inductor wiring 30, most of the magnetic flux in a direction along the first virtual straight line VL1 passes through a portion of the second magnetic thin strip 41A excluding an end in the direction along the first axis X, in the vicinity of the first wiring end IP1 of the inductor wiring 30. That is, in the magnetic flux generated when a current flows through the inductor wiring 30, the magnetic flux passing through an end in a direction along the second magnetic thin strip 41A is reduced. Therefore, disturbance of the magnetic flux and local concentration of the magnetic flux may be suppressed. With such a positional relationship between the second magnetic thin strip 41A and the inductor wiring 30, the inductance L increases regardless of a filling rate of a magnetic material.
(1-6) According to the first embodiment, the multiple magnetic thin strips 40 are continuously laminated in the direction along the second axis Z relative to the inductor wiring 30. Then, in a sectional view orthogonal to the center axis CA, the first virtual straight line VL1 passes through the first range AR1 of two or more magnetic thin strips 40 continuously laminated including the second magnetic thin strip 41A. Therefore, according to the positional relationship between the inductor wiring 30 and not only the second magnetic thin strip 41A but also another magnetic thin strip 40, the characteristic indices may further be increased.
(1-7) According to the first embodiment, in a sectional view orthogonal to the center axis CA, the first virtual straight line VL1 passes through the first range AR1 of all the magnetic thin strips 40 continuously laminated to the second magnetic thin strip 41A. Therefore, since it is possible to avoid passing through the end of the magnetic thin strip 40 in the direction along the first axis X, the characteristic indices may further be increased.
(1-8) The magnetic flux generated when a current flows through the inductor wiring 30 in the direction along the center axis CA includes the magnetic flux intruding into the magnetic thin strip 40 in the direction along the second axis Z. The intruding magnetic flux as described above generates an eddy current in the magnetic thin strip 40. Further, in a view from the direction along the second axis Z, the eddy current increases as an area of each magnetic thin strip 40 increases. When the eddy current occurs, since energy of the magnetic flux is lost as thermal energy, loss occurs.

According to the first embodiment, two magnetic thin strips 40 are arranged side by side in the direction along the first reference axis and two magnetic thin strips 40 are arranged side by side in the direction along the second reference axis at the same position along the second axis Z. Therefore, the area of the magnetic thin strip 40 in a view from the direction along the second axis Z becomes smaller than that in a case that one magnetic thin strip 40 is provided at the same position along the second axis Z. Therefore, the eddy current generated in one magnetic thin strip 40 is reduced.
(1-9) According to the first embodiment, two magnetic thin strips 40 are arranged side by side in the direction along the first axis X at the same position along the second axis Z. Therefore, the second magnetic thin strip 41A through which the first virtual straight line VL1 passes and the third magnetic thin strip 41B through which the third virtual straight line VL3 passes are different magnetic thin strips 40. In the case above, the first virtual straight line VL1 passes through the first wiring end IP1 of the inductor wiring 30, and the third virtual straight line VL3 passes through the second wiring end IP2 of the inductor wiring 30. Therefore, while securing a certain measurement as a length of the inductor wiring 30 in the direction along the first axis X, there may be achieved the positional relationship described above as a positional relationship between the inductor wiring 30 and the second magnetic thin strip 41A.
(1-10) According to the first embodiment, the element body 20 includes the nonmagnetic portion 60 made of a nonmagnetic material of a sintered body. The nonmagnetic portion 60 is positioned between the magnetic thin strips 40 adjacent to each other in the direction along the first reference axis, and between the magnetic thin strips 40 adjacent to each other in the direction along the second reference axis. In the case above, the nonmagnetic portion 60 positioned at the same position on the second axis Z as the magnetic thin strip 40 may be sintered in the same step as the step of forming the magnetic thin strip 40 into a sintered body.
(1-11) According to the first embodiment, the element body 20 includes the interlayer nonmagnetic portion 50 made of a nonmagnetic material of a sintered body. The interlayer nonmagnetic portion 50 is positioned between the magnetic thin strips 40 adjacent to each other in the lamination direction of the multiple magnetic thin strips 40. In the case above, the interlayer nonmagnetic portion 50 may be sintered in the same step as the step of forming the magnetic thin strip 40, laminated in the lamination direction, into a sintered body.
(1-12) According to the first embodiment, measurements of the multiple magnetic thin strips 40 in the direction along the second axis Z are all equal. Therefore, the magnetic flux density in each of the magnetic thin strips 40 becomes uniform, and saturation of the magnetic flux due to concentration at a specific portion is unlikely to occur. As a result, the magnetic flux density of the entire element body 20 increases.
(1-13) According to the first embodiment, measurements of the multiple interlayer nonmagnetic portions 50 in the direction along the second axis Z are all equal. Therefore, disturbance of the magnetic flux generated at an interface between the interlayer nonmagnetic portion 50 and the magnetic thin strip 40 may be made uniform.

### Second Embodiment

(Inductor Component)

An inductor component 110 according to a second embodiment is different from the inductor component 10 according to the first embodiment in the configuration of the second portion P2. Hereinafter, differences from the inductor component 10 according to the first embodiment will be described.

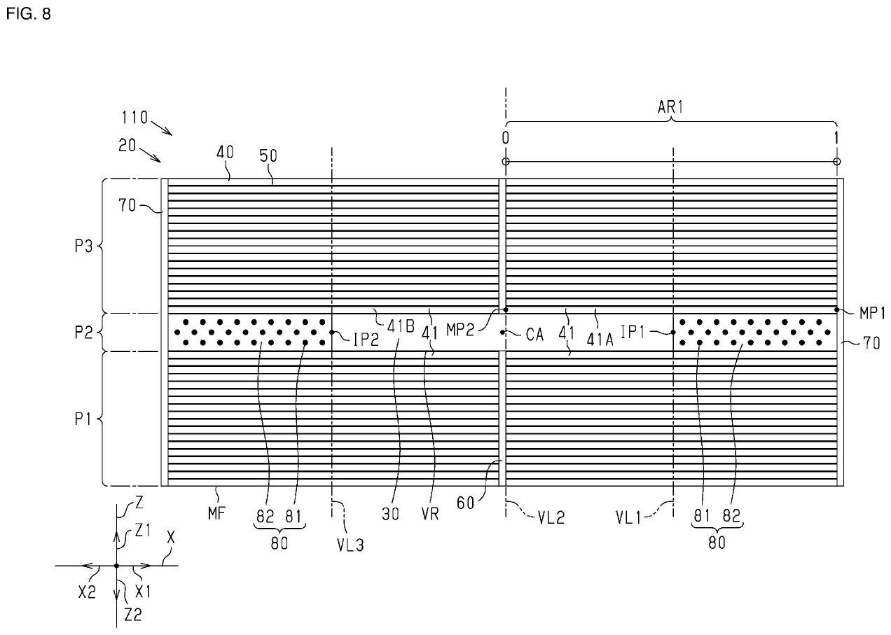

The second portion P2 is constituted of the inductor wiring 30 and two composite portions 80 as illustrated in FIG. 8. The composite portion 80 includes a powdery magnetic particle 81 made of a magnetic material and a nonmagnetic base material 82 made of a nonmagnetic material. The magnetic particle 81 is a magnetic metal particle containing the Fe element, the Ni element, the Co element, a Cr element, a Cu element, an Al element, the Si element, a B element, a P element, or the like, for example. In the present embodiment, the magnetic particle 81 is a metal particle of an alloy containing the Fe element, the Si element, and the Cr element. The nonmagnetic base material 82 is an inorganic sintered body such as glass or alumina, for example.

The composite portion 80 has a rectangular shape in a view from the direction along the second axis Z. In a view from the direction along the second axis Z, the long side of the composite portion 80 is parallel to the center axis CA. The direction of the composite portion 80 in the direction along the second axis Z is parallel to the inductor wiring 30.

In the second portion P2, two composite portions 80 are positioned on both sides of the first positive direction X1 and the first negative direction X2 along the first axis X in a view from the inductor wiring 30 as illustrated in FIG. 8. That is, in the second portion P2, two composite portions 80 are arranged in the direction along the first axis X sandwiching the inductor wiring 30.

(Method for Manufacturing Inductor Component)

Next, a method of manufacturing the inductor component 110 will be described.

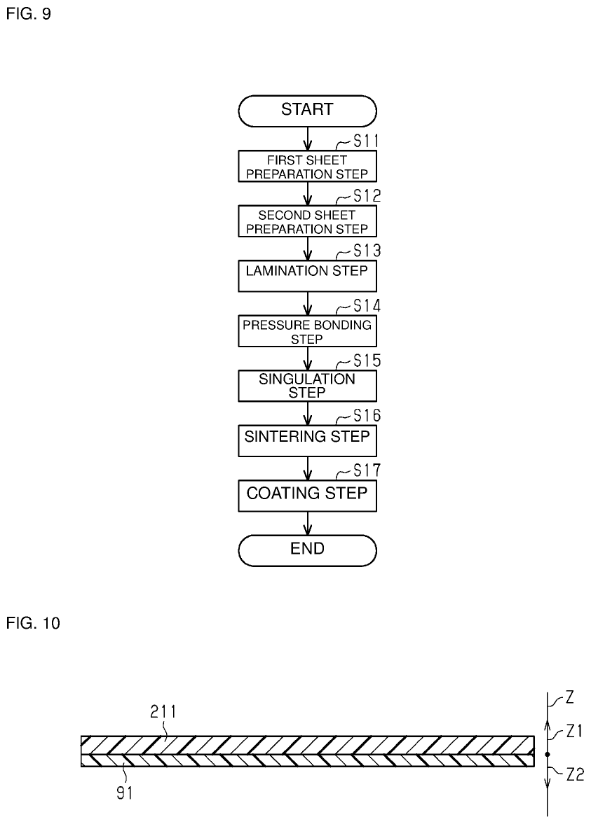

The method of manufacturing the inductor component 110 includes a first sheet preparation step S11, a second sheet preparation step S12, a lamination step S13, a pressure bonding step S14, a singulation step S15, a sintering step S16, and a coating step S17, as illustrated in FIG. 9.

First, the first sheet preparation step S11 is performed. A first sheet 210 includes a nonmagnetic layer 211 and a magnetic layer 212 containing a magnetic metal powder 212M being a magnetic material. In order to manufacture the first sheet 210, first, a film made of PET is prepared as a first base member 91 as illustrated in FIG. 10. The first base member 91 may be a material, which is removed after completion of a component, such as a substrate made of PET, alumina, or ferrite, or may be a material which remains after the completion of a component, such as the nonmagnetic layer 211 made of glass. Note that, in the following description, it is assumed that the two main faces of the first base member 91 are arranged to be orthogonal to the second axis Z, and the description is made using the section orthogonal to the center axis CA. Further, in FIG. 10 to FIG. 18, ratios of measurements are greatly changed from those in FIG. 8 to facilitate understanding.

A main face of the first base member 91 facing the second positive direction Z1 along the second axis Z is applied with a nonmagnetic paste made of a nonmagnetic and insulative nonmagnetic material and is formed into a sheet shape. Thus, the nonmagnetic layer 211 is formed. The nonmagnetic layer 211 is made of a nonmagnetic material containing alumina, silica, crystallized glass, amorphous glass, or the like, for example.

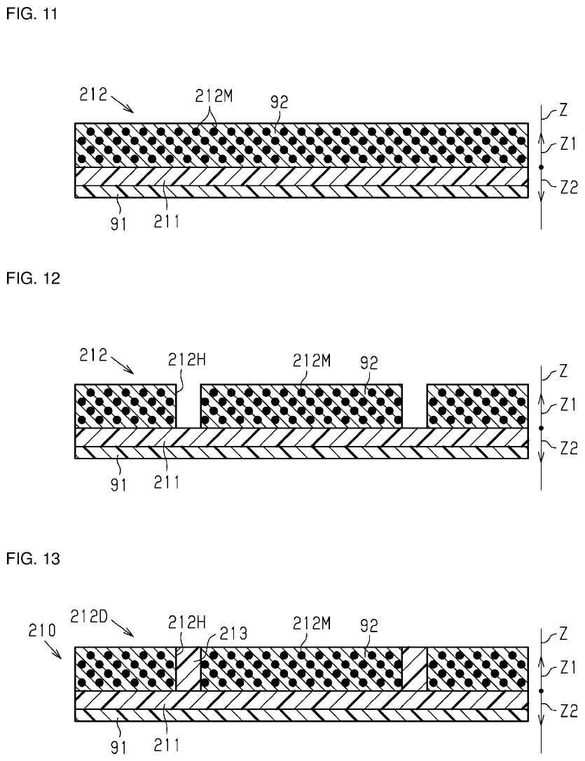

Next, a face of the nonmagnetic layer 211 facing the second positive direction Z1 along the second axis Z is applied with a magnetic metal paste containing the magnetic metal powder 212M being a magnetic material as illustrated in FIG. 11. In the present embodiment, the magnetic metal powder 212M is an Fe—Ni alloy containing the Fe element and the Ni element. Thus, the magnetic layer 212 is formed. The magnetic layer 212 is made of a magnetic metal paste in which the magnetic metal powder 212M is contained in a resin 92.

Next, a groove 212H is formed in the magnetic layer 212 by laser processing as illustrated in FIG. 12. The groove 212H penetrates through the magnetic layer 212. In a view from the direction along the second axis Z, part of the nonmagnetic layer 211 is exposed from the groove 212H in the second positive direction Z1 along the second axis Z. The groove 212H divides the magnetic layer 212 in the direction along the first reference axis and the direction along the second reference axis in a view from the direction along the second axis Z.

Next, the groove 212H formed in the magnetic layer 212 is filled with a nonmagnetic paste made of a nonmagnetic and insulative material by printing or the like as illustrated in FIG. 13. Thus, an in-groove nonmagnetic portion 213 is formed. At the same time, multiple divided magnetic layers 212D are formed by dividing the magnetic layer 212 in the direction along the first reference axis and in the direction along the second reference axis. Further, the first sheet 210 is prepared by forming the divided magnetic layer 212D into a sheet shape. Note that the first sheets 210 are prepared in the same number as the number of layers of the magnetic thin strips 40 in the inductor component 10 to be manufactured.

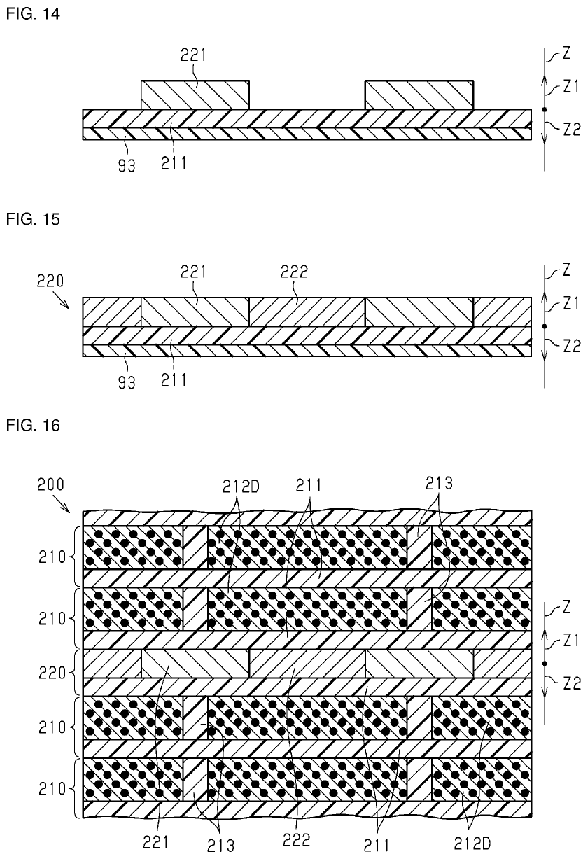

Next, the second sheet preparation step S12 is performed. A second sheet 220 has a wiring pattern 221 and a negative pattern 222. First, before manufacturing the second sheet 220, a second base member 93 is prepared as illustrated in FIG. 14. The second base member 93 may be a material, which is removed after completion of a component, such as a substrate made of PET, alumina, or ferrite, or may be a material which remains after the completion of a component, such as the nonmagnetic layer 211 made of glass. Note that, in the following description, it is assumed that two main faces of the second base member 93 are arranged to be orthogonal to the second axis Z.

A main face of the second base member 93 facing the second positive direction Z1 along the second axis Z is applied with a nonmagnetic paste made of a nonmagnetic and insulative nonmagnetic material and is formed into a sheet shape. Thus, the nonmagnetic layer 211 is formed.

Next, a conductive paste is partially applied by printing or the like to a main face of the nonmagnetic layer 211 facing the second positive direction Z1 along the second axis Z. Thus, the wiring pattern 221 is formed. The wiring pattern 221 is made of a conductive material. For example, the wiring pattern 221 is made of a conductive paste of Ag or Cu.

Note that the method of forming the wiring pattern 221 may be a photolithography method using a photosensitive material, a plating method such as a semi-additive method, a transfer method of transferring a wiring pattern formed on another sheet, or the like, in addition to printing such as a screen printing method. Further, in a case of the plating method or the transfer method, a metal film containing no resin may be used as the material of the wiring pattern 221 instead of the conductive paste.

Next, a negative paste is applied by printing or the like to a portion of the main face of the nonmagnetic layer 211, facing the second positive direction Z1 along the second axis Z, on which the wiring pattern 221 is not applied as illustrated in FIG. 15. Thus, the negative pattern 222 is formed. Although not illustrated, the negative pattern 222 includes the magnetic particle 81 and nonmagnetic powder being a raw material of the nonmagnetic base material 82. Thus, the second sheet 220 is prepared. In the present embodiment, the nonmagnetic layer 211 is a sheet-shaped base member for forming the wiring pattern 221 and the negative pattern 222.

Next, the lamination step S13 to laminate the prepared first sheet 210 and the second sheet 220 is performed. First, the first base member 91 is peeled off from the first sheet 210, and the sheet is placed on a predetermined jig table (not illustrated) with the vertical direction of the sheet unchanged, as illustrated in FIG. 16. Then, a face of the wiring pattern 221 and the negative pattern 222 are applied on nonmagnetic layer 211 of the second sheet 220, facing a direction opposite to a face on which a nonmagnetic layer 211 is applied, and a face of the nonmagnetic layer 211 of the first sheet 210, facing a direction opposite to a face on which the magnetic layer 212 is applied, are made to face each other and are bonded. Thus, the first sheet 210 is laminated on the second sheet 220 in the second positive direction Z1 along the second axis Z.

In the same manner, the first base member 91 is peeled off from another first sheet 210. Then, a surface of the first sheet 210 laminated on the second sheet 220, facing a direction opposite to the face bonded to the second sheet 220, and a face of the nonmagnetic layer 211 of another first sheet 210, facing a direction opposite to the face on which the magnetic layer 212 is applied, are made to face each other and are bonded. Although not illustrated, laminated are the first sheets 210 of the same number as that of the magnetic thin strips 40 laminated in the third portion P3 of the inductor component 10.

Next, the second base member 93 is peeled off from the second sheet 220. Then, a face of the nonmagnetic layer 211 of the second sheet 220, facing a direction opposite to the face on which the wiring pattern 221 and the negative pattern 222 are applied, and a face of the magnetic layer 212 of the first sheet 210, facing a direction opposite to the face on which the nonmagnetic layer 211 is applied, are made to face each other and are bonded. Then, the first base member 91 is peeled off from the first sheet 210.

In the same manner, a face of the nonmagnetic layer 211 of the first sheet 210 laminated on the second sheet 220, facing a direction opposite to the face on which the magnetic layer 212 is applied, and a face of the magnetic layer 212 of another first sheet 210, facing a direction opposite to the face on which the nonmagnetic layer 211 is applied, are made to face each other and are bonded. Although not illustrated, laminated are the first sheets 210 of the same number as that of the magnetic thin strips 40 laminated in the first portion P1 of the inductor component 10. Thus, the first sheet 210 are repeatedly laminated on both main faces of the second sheet 220. That is, when a multilayer body 200 is formed, multiple divided magnetic layers 212D are laminated.

Next, the pressure bonding step S14 is performed. The first sheet 210 and the second sheet 220 laminated in the lamination step S13 are pressure bonded by pressing with WIP (Warm Isostatic Press) or the like. Thus, the multilayer body 200 is formed.

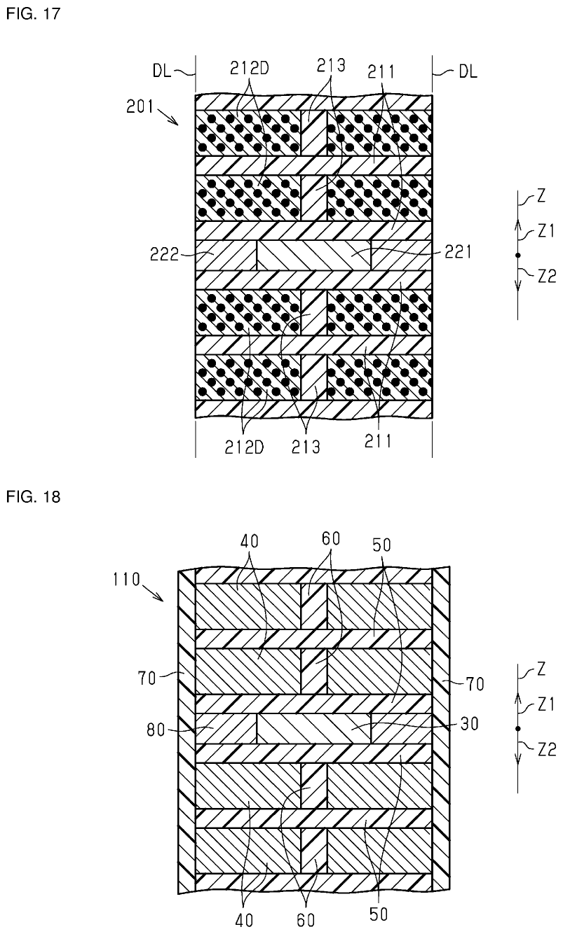

Next, the singulation step S15 is performed. The multilayer body 200 is singulated by cutting with a dicing machine along a predetermined break line DL as illustrated in FIG. 17, for example. Thus, a singulated portion 201 obtained by singulating the multilayer body 200 is formed. The singulated portion 201 is constituted of the wiring pattern 221 and the divided magnetic layer 212D. The multiple singulated portions 201 are arranged in a matrix in the multilayer body 200 so as to be aligned in the direction along the first reference axis and the direction along the second reference axis. Note that, in the present embodiment, the singulated portion 201 has one wiring pattern 221.

Next, the sintering step S16 is performed. The singulated portion 201 of the multilayer body 200 singulated in the singulation step S15 is sintered by firing for a predetermined time as illustrated in FIG. 18. Thus, the wiring pattern 221 becomes the inductor wiring 30 of a sintered body. The negative pattern 222 becomes the composite portion 80 of a sintered body. The nonmagnetic layer 211 becomes the interlayer nonmagnetic portion 50 of a sintered body. The in-groove nonmagnetic portion 213 becomes the nonmagnetic portion 60 of a sintered body. Then, the magnetic metal powder 212M of the magnetic layer 212 becomes the magnetic metal body 45 of a sintered body made of the magnetic material. On the other hand, the resin contained in the singulated portion 201 of the multilayer body 200 is vaporized by being heated.

Next, the coating step S17 is performed. A face including the break line DL cut with a dicing machine in the singulation step S15 is covered with a nonmagnetic film 70 being a nonmagnetic insulative body. As a result, the singulated portion 201 becomes the inductor component 110. Note that, by the sintering step S16, the volume of the inductor component 110 becomes smaller than the volume of the singulated portion 201.

### Action of Second Embodiment

With the use of the inductor component 110 of the second embodiment, the magnetic metal powder 212M of the magnetic layer 212 becomes a sintered body made of a magnetic material by the sintering step S16.

### Effects of Second Embodiment

The second embodiment is different from the first embodiment in that the configuration of the magnetic thin strip 40 and the interlayer nonmagnetic portion 50 in the second portion P2 is exchanged by the composite portion 80. Therefore, the configurations of the magnetic thin strips 40 and the interlayer nonmagnetic portions 50 in the first portion P1 and the third portion P3 are the same as those in the first embodiment. In the inductor component 110 according to the second embodiment, the same tendency as in the simulation result of the inductor component 10 according to the first embodiment is obtained. According to the second embodiment, the following effects are achieved in addition to the effects (1-1) to (1-13) in the first embodiment described above.
(2-1) In the second embodiment, the magnetic material of the magnetic thin strip 40 is permendur composed of the Fe element and the Co element. Such a crystalline magnetic metal material has extremely high saturation magnetic flux density Bs among magnetic metal materials. Therefore, from a viewpoint of the DC superposition characteristic Isat, it is suitable as a material of the element body 20 in a power inductor or the like used at a high current value Idc.

However, a crystalline magnetic metal material such as permendur composed of the Fe element and the Co element has a very large magnetostriction constant. That is, the crystalline magnetic metal material is a material causing a large amount of change in a measurement when a magnetic field is generated. In addition, when the element body 20 is formed, strain of the crystalline magnetic metal material tends to remain due to stress at a time of applying pressure or the like. In a state in which such strain at the time of processing remains, the permeability μ decreases, or large coercive field strength is required to return to a non-magnetized state.

Here, in the second embodiment, the residual strain generated by the processing in the sintering step S16 may be reduced. Thus, since the characteristics recovered by reducing the strain may become large, the effect obtained by adopting the sintered body is greatly exhibited with the crystalline magnetic metal material.
(2-2) According to the second embodiment, the portion of the second portion P2 that is not the inductor wiring 30 is constituted of the composite portion 80. In the composite portion 80, the magnetic particles 81 are randomly dispersed. Therefore, when the magnetic flux generated in the direction along the second axis Z intrudes into the magnetic material of the second portion P2, an eddy current generated in the composite portion 80 is reduced.
(2-3) If the magnetic thin strips 40 after sintering are laminated one by one in one inductor component 10, it takes time and effort. According to the second embodiment, the multilayer body 200 including the multiple singulated portions 201 is formed. Then, the singulated portion 201 is formed by singulating the multilayer body 200. Thereafter, the inductor component 10 is manufactured by sintering the singulated portion 201. Therefore, the singulated portion 201, in which the multiple magnetic thin strips 40 are laminated, may be efficiently manufactured.
(2-4) According to the second embodiment, the first sheet 210 is prepared by forming the divided magnetic layer 212D into a sheet shape. Further, the second sheet 220 is prepared by forming the wiring pattern 221 on the nonmagnetic layer 211 as a sheet-shaped base member. Then, the first sheet 210 and the second sheet 220 are pressure bonded to each other to form the multilayer body 200. Therefore, in forming the multilayer body 200, the multilayer body 200 may be formed by a step of preparing two kinds of sheets, a step of lamination, and a step of pressure bonding.
(2-5) According to the second embodiment, the multilayer body 200 is formed by forming the divided magnetic layer 212D on the wiring pattern 221. The position of the divided magnetic layer 212D may be adjusted using the wiring pattern 221 as a reference.
(2-6) According to the second embodiment, in preparing the second sheet 220, the negative pattern 222 is formed on a portion of the nonmagnetic layer 211 as a sheet-shaped base member, the portion on which the wiring pattern 221 is not formed. Therefore, the position of the composite portion 80 in the inductor component 110 is easily adjusted.
(2-7) According to the second embodiment, when the multilayer body 200 is formed, the multiple divided magnetic layers 212D are laminated. Therefore, the number of the multiple magnetic thin strips 40, laminated in the lamination direction of the inductor component 110, is easily adjusted.

### Other Embodiments

Each of the embodiments may be modified as follows. The embodiments and the following modification may be combined with each other as long as no technical contradiction arises.

In each of the embodiments, the shape of the element body 20 is not limited to the example of each of the embodiments. For example, in a view from the direction along the second axis Z, the shape of the element body 20 may be a rectangular shape or a polygonal shape other than a quadrangular shape. Further, for example, in a view from the direction along the second axis Z, the shape of the element body 20 may be a circular shape such as an ellipse. Furthermore, the shape of the element body 20 may be a rectangular parallelepiped, a cube, a polygonal column, a cylinder, or the like in which the measurements in the first reference axis and the second reference axis are different from each other.

In each of the embodiments, the shape of the inductor wiring 30 may be appropriately changed as long as the inductor wiring 30 may provide the inductance L to the inductor component 10 by generating a magnetic flux in the element body 20 when a current flows therethrough. For example, as in the simulation described above, both ends of the inductor wiring 30 may protrude from the element body 20.

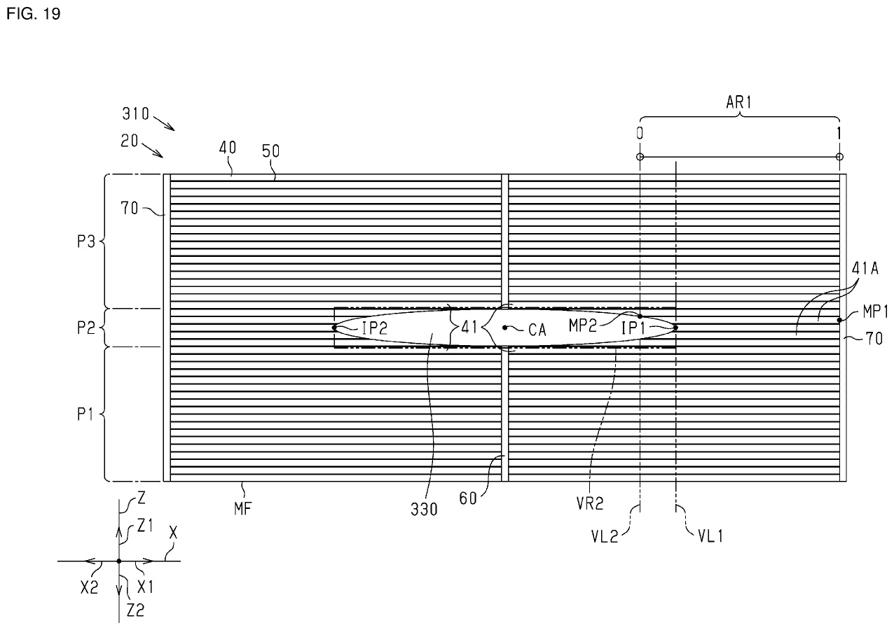

Further, for example, in an inductor component 310 of a modification illustrated in FIG. 19, an inductor wiring 330 has an elliptical shape in the section orthogonal to the center axis CA. Then, drawn is a virtual rectangle VR2 with the minimum area, circumscribing the inductor wiring 330, and having a first side along the first axis X and a second side along the second axis Z. At this time, the first side of the virtual rectangle VR2 is longer than the second side of the virtual rectangle VR2. As described above, when the long side of the virtual rectangle VR2 is parallel to the first axis X, a region of the first magnetic thin strip 41, in which the demagnetizing field is small, corresponds to an end portion of a section of a wiring line in the direction along the first axis X in which the magnetic flux concentrates more. This provides a preferable case.

In the embodiment, in the shape of the inductor wiring 30 in the section orthogonal to the center axis CA, the second side along the second axis Z may be longer than the first side along the first axis X. Even in the case above, the magnetic flux concentrates on the first wiring end IP1 being an end of the inductor wiring 30 in the first positive direction X1. Therefore, the region of the first magnetic thin strip 41, in which the demagnetizing field is small, corresponds to the first wiring end IP1 of the section of the wiring line in which the magnetic flux concentrates more. This provides a preferable case.

Furthermore, in the section orthogonal to the center axis CA, the inductor wiring 30 may have an asymmetrical shape, such as reflection symmetry or rotational symmetry, because of having one or more protrusions, or the like. As described above, when the symmetry does not exist in the section orthogonal to center axis CA, arises a portion where the magnetic flux concentrates more than in other portions. It is preferable to determine a positional relationship of the second magnetic thin strip 41A such that the first wiring end IP1 is a portion, such as the protrusion, where the magnetic flux concentrates more than in other portions.

Further, for example, in the section orthogonal to the center axis CA, the shape of the inductor wiring 30 may be a square shape or a perfect circle shape. In the case above, the virtual rectangle VR drawn in the section orthogonal to the center axis CA is a square, and a first side of the virtual rectangle VR does not need to be longer than a second side of the virtual rectangle VR.

Note that the first magnetic thin strip 41, the second magnetic thin strip 41A, and the third magnetic thin strip 41B are determined in accordance with the shape of the inductor wiring 30 in the section orthogonal to the center axis CA. In the modification illustrated in FIG. 19, among the magnetic thin strips 40 laminated in the direction along the second axis Z relative to the inductor wiring 330, the magnetic thin strip 40 having the shortest distance along the second axis Z from the first wiring end IP1 is one of the magnetic thin strips 40 included in the second portion P2. Further, the first magnetic thin strip 41 is the magnetic thin strip 40 closest to the inductor wiring 30 among the magnetic thin strips laminated relative to the inductor wiring 30. Therefore, the first magnetic thin strip 41 is the magnetic thin strip 40 closest to the inductor wiring 30 in the first portion P1 and is the magnetic thin strip 40 closest to the inductor wiring 30 in the third portion P3. That is, in the modification illustrated in FIG. 19, the second magnetic thin strip 41A is not the first magnetic thin strip 41.

In each of the embodiments, the position of the inductor wiring 30 in the direction along the first axis X is not limited to the example of each of the embodiments. For example, the center of the inductor wiring 30 in the direction along the first axis X does not need to coincide with a center of the element body 20 in the direction along the first axis X.

In each of the embodiments, the shape of the inductor wiring 30 is not limited to a linear shape. The inductor wiring 30 only needs to extend along the main face MF of the magnetic thin strip 40 and may have a curved shape or a meander shape as a whole, for example. When the inductor wiring 30 extends on the same plane, the arrangement of the first wiring end IP1 of the inductor wiring 30 and the second magnetic thin strip 41A is easily adjusted.

In each of the embodiments, the material of the inductor wiring 30 is not limited to the example of each of the embodiments as long as being a conductive material. For example, the material of the inductor wiring 30 may be a conductive resin.

In each of the embodiments, the center axis CA and the first reference axis does not need to coincide with each other. Further, the second reference axis does not need to coincide with the first axis X. For example, when the shape of the inductor wiring is a meander shape as described above, the center axis CA extends in a meander shape. In the case above, it is needed that the first reference axis is orthogonal to the second axis Z, and the second reference axis is orthogonal to the second axis Z and intersects with the first reference axis. Even in the case above, when the multiple magnetic thin strips 40 are arranged side by side in the direction along the first reference axis or the multiple magnetic thin strips 40 are arranged side by side in the direction along the second reference axis, the area of the magnetic thin strip 40 in a view from the direction along the second axis Z is smaller than that in a case that one magnetic thin strip 40 is arranged at the same position along the second axis Z. Therefore, the eddy current generated in one magnetic thin strip 40 is reduced.

The positional relationship between the first virtual straight line VL1 passing through the first wiring end IP1 and the first range AR1 of the second magnetic thin strip 41A described in each of the embodiments needs to be satisfied in any one section among sections of the inductor wiring 30 orthogonal to the center axis CA. That is, the positional relationship between the first virtual straight line VL1 and the first range AR1 of the second magnetic thin strip 41A does not need to be satisfied in the entire region of the inductor wiring 30. Note that there may be no section satisfying the positional relationship between the first virtual straight line VL1 passing through the first wiring end IP1 and the first range AR1 of the second magnetic thin strip 41A. That is, a position of the first wiring end IP1 of the inductor wiring 30 in the direction along the first axis X does not need to be within the first range AR1 of the second magnetic thin strip 41A, and may coincide with an end of the second magnetic thin strip 41A in the direction along the first axis X.

In each of the embodiments, an outer electrode may be connected to a portion of the inductor wiring 30 exposed from the element body 20. For example, outer electrodes may be formed on both end faces of the inductor wiring 30 in the direction along the center axis CA, and on both end faces of the element body 20 in the direction along the center axis CA by applying, printing, plating, or the like.

In each of the embodiments, the direction in which the magnetic thin strip 40 and the interlayer nonmagnetic portion 50 are laminated is not necessarily orthogonal to the center axis CA and the first axis X due to manufacturing error or the like. In each of the embodiments, the expression that the magnetic thin strips 40 and the like are “laminated in the direction along the second axis Z” allows such manufacturing error or the like.

In each of the embodiments described above, the number of magnetic thin strips 40 laminated in the direction along the second axis Z needs to be two or more. In the case above, the inductor wiring 30 and the interlayer nonmagnetic portion 50 need to be arranged between the two magnetic thin strips 40.

In each of the embodiments, the magnetic thin strips 40 and the interlayer nonmagnetic portions 50 do not need to be completely alternately laminated.

In each of the embodiments, the inductor wiring 30 does not need to be formed of a single layer but may be formed of multiple layers.

In each of the embodiments described above, the material of the magnetic thin strip 40 is not limited to the example of each of the embodiments as long as being a magnetic material. For example, Fe or Ni may be used. An alloy containing the Fe element and the Co element may also be used. Further, an alloy containing at least two or more of the Fe element, the Ni element, the Co element, the Cr element, the Cu element, the Al element, the Si element, the B element, and the P element may also be used. Furthermore, a mixture containing at least two or more of Fe, Ni, Co, Cr, Cu, Al, Si, B, and P may also be used. A magnetic material having a large permeability μ is suitable for improving the initial inductance Lin of an inductor component.

In each of the embodiments, the magnetic metal body 45 of the magnetic thin strip 40 is not limited to an alloy of the Fe element and the Ni element and may be Fe or Ni. An alloy containing the Fe element and the Co element may also be used. Further, an alloy containing at least two or more of the Fe element, the Ni element, the Co element, the Cr element, the Cu element, the Al element, the Si element, the B element, and the P element may also be used. Furthermore, a mixture containing at least two or more of Fe, Ni, Co, Cr, Cu, Al, Si, B, and P may also be used. The material of the magnetic metal body 45 may appropriately be changed in accordance with characteristics required as an inductor component, conditions of the sintering step S16, or the like.

In each of the embodiments, the insulative substance 46 of the magnetic thin strip 40 is not limited to an oxide containing the Oxygen element, which is altered from a metal contained in the magnetic metal powder 212M before sintering. For example, a micro amount of the Si element may be contained in the magnetic metal powder 212M before sintering, and the Si element may be vitrified during sintering of the magnetic metal powder 212M and pushed out to the surface of the magnetic metal body 45 to form the insulative substance 46, after sintering. In the case above, the insulative substance 46 contains the Si element. For example, when the magnetic metal body 45 is an alloy containing the Fe element, the Si element, and the Cr element, the magnetic metal body 45 is an Fe—Si—Cr alloy, and the Si element and the Cr element are present in the grain boundary. That is, among elements contained in the magnetic metal powder 212M before sintering, those having a high diffusion rate are present in the grain boundary. As described above, the gaps between the magnetic metal bodies 45 are filled with the components having a higher diffusion rate than the magnetic materials among the components contained in the magnetic metal powder 212M, and thus a sintered body having a higher density is obtained. In the case above, the insulative substance 46 includes the Si element and the Cr element. The insulative substance 46 does not need to be present at the grain boundary of the magnetic metal bodies 45.

In each of the embodiments, the material of the interlayer nonmagnetic portion 50 is not limited to the example of each of the embodiments as long as being a nonmagnetic material. The interlayer nonmagnetic portion 50 may be partially made of resin such as an acrylic resin, an epoxy resin, or a silicon resin. The same applies to the nonmagnetic portion 60 and the nonmagnetic film 70. Further, the materials of the interlayer nonmagnetic portion 50, the nonmagnetic portion 60, and the nonmagnetic film 70 may be different from each other or partially different from each other as long as being nonmagnetic materials. The cases above are achieved by coating a face of the singulated portion 201 with resin, or by filling the space with resin from an outer side portion after the sintering step S16. Note that, when the interlayer nonmagnetic portion 50 is formed of a sintered body as in the manufacturing method described in the second embodiment, a material that can be sintered, such as alumina, silica, crystallized glass, or amorphous glass, is suitable as the nonmagnetic paste. Further, the material of the interlayer nonmagnetic portion 50, the nonmagnetic portion 60, and the nonmagnetic film 70 may be nonmagnetic ceramics other than alumina and glass, a nonmagnetic inorganic substance containing these materials, or a mixture of these materials including a gap.

Further, when the nonmagnetic paste is resin, gaps are formed between the magnetic thin strips 40 due to scattering of the resin. However, the interlayer nonmagnetic portion 50 may be a gap, for example. Further, the interlayer nonmagnetic portion 50 may be made of resin such that sheets of the magnetic layers 212 are fired one by one, then the sheets are bonded with each other using a resin layer being an adhesive.

In the embodiment, the interlayer nonmagnetic portion 50, the nonmagnetic portion 60, and the nonmagnetic film 70 may be integrated, or may be separate members. For example, the interlayer nonmagnetic portion 50 may be hollow or may be configured such that an oxide film obtained by oxidizing the surface of the magnetic thin strip 40 serves as an insulative body.

In the embodiment, the interlayer nonmagnetic portion 50 may be omitted. In the case above, the magnetic thin strips 40 adjacent to each other in the direction along the second axis Z may be in direct contact with each other.

In the embodiment, the nonmagnetic portion 60 may be omitted. In the case above, the magnetic thin strips 40 arranged side by side in the direction along the first reference axis or the second reference axis may be in direct contact with each other. Further, the nonmagnetic portion 60 may be present between the inductor wiring 30 and the magnetic thin strip 40. In the case above, insulation between the inductor wiring 30 and the magnetic thin strip 40 may be ensured by the nonmagnetic portion 60.

Note that expressions “multiple magnetic thin strips 40 are laminated” and “multiple magnetic thin strips 40 are arranged side by side” specifically refer to a case that magnetic thin strips 40 adjacent to each other are completely or partially insulated from each other, or a case that a physical boundary is microscopically present. For example, a state in which the magnetic thin strips 40 are sintered to be completely integrated is not included.

In each of the embodiments, as long as the second magnetic thin strip 41A is present in at least one of the first portion P1 and the third portion P3, the configuration of the magnetic thin strip 40, the interlayer nonmagnetic portion 50, and the nonmagnetic portion 60 may be changed. For example, the entire portion of the second portion P2 excluding the inductor wiring 30 may be configured by the magnetic thin strip 40 or by the interlayer nonmagnetic portion 50.

According to each of the embodiments, two magnetic thin strips 40 are arranged side by side in the direction along the first axis X at the same position along the second axis Z, and two magnetic thin strips 40 are arranged side by side in the direction along the center axis CA, that is, the first reference axis. That is, when “M” and “N” are positive integers, at the same position along the second axis Z, the “M” magnetic thin strips 40 are arranged in the direction along the first reference axis, and the “N” magnetic thin strips 40 are arranged in the direction along the first axis X, that is, the second reference axis, and both “M” and “N” are two. In each of the embodiments, “M”, being the number of the magnetic thin strips 40 arranged side by side in the direction along the second reference axis, may be one, or may be three or more. Further, “N”, being the number of the magnetic thin strips 40 arranged side by side in the direction along the center axis CA, may be one, or three or more. Note that, when at least one of “M” and “N” is two or more, the area of each magnetic thin strip 40 in a view from the second axis Z may be made small, and thus loss due to an eddy current may easily be reduced.

In each of the embodiments, measurements of the multiple magnetic thin strips 40 in the direction along the second axis Z may be different from each other. When the measurement of the magnetic thin strip 40 in the direction along the second axis Z is small, manufacturing error of approximately 20% may occur depending on a manufacturing method. Therefore, the measurements of the magnetic thin strips 40 in the direction along the second axis Z may be considered to be substantially equal, when the measurements each are 80% or more and 120% or less (i.e., from 80% to 120%) of an average value of the measurements of the multiple magnetic thin strips 40 in the direction along the second axis Z. Note that the measurement of one magnetic thin strip 40 in the direction along the second axis Z is the minimum measurement in the direction along the second axis Z in one image obtained with a magnification from 1000 times to 10000 times under an electron microscope. Further, the measurement of the multiple magnetic thin strips 40 in the direction along the second axis Z is the average value of the measurement of one magnetic thin strip 40 in the direction along the second axis Z. The measurement of one magnetic thin strip 40 is taken from five or more magnetic thin strips 40 in one image under an electron microscope.

The measurements of the multiple magnetic thin strips 40 in the direction along the second axis Z does not need to be the same as each other and may vary by more than 20% relative to the average value.

In each of the embodiments, the measurements of the multiple interlayer nonmagnetic portions 50 in the direction along the second axis Z may be different from each other. When the measurement of the interlayer nonmagnetic portion 50 in the direction along the second axis Z is small, manufacturing error of approximately 20% may occur depending on a manufacturing method. Therefore, the measurements of the interlayer nonmagnetic portions 50 in the direction along the second axis Z may be considered to be substantially equal, when the measurements each are 80% or more and 120% or less (i.e., from 80% to 120%) of an average value of the measurements of the multiple interlayer nonmagnetic portions 50 in the direction along the second axis Z. Note that the measurement of one interlayer nonmagnetic portion 50 in the direction along the second axis Z is the minimum measurement in the direction along the second axis Z in one image obtained with a magnification from 1000 times to 10000 times under an electron microscope. Further, the measurement of the multiple interlayer nonmagnetic portions 50 in the direction along the second axis Z is the average value of the measurement of one interlayer nonmagnetic portion 50 in the direction along the second axis Z. The measurement of one interlayer nonmagnetic portion 50 is taken from five or more interlayer nonmagnetic portions 50 in one image under an electron microscope.

The measurements of the multiple interlayer nonmagnetic portions 50 in the direction along the second axis Z does not need to be the same as each other and may vary by more than 20% relative to the average value.

In each of the embodiments, the number and positions of the nonmagnetic portions 60 are not limited to the example of each of the embodiments. The number and positions of the nonmagnetic portions 60 may be changed in accordance with the number and positions of the magnetic thin strips 40 in the direction along the first axis X or the direction along the center axis CA. Further, the measurement of the nonmagnetic portion 60 may appropriately be changed in accordance with the interval between the magnetic thin strips 40 at the same position in the direction along the second axis Z.

In each of the embodiments, the nonmagnetic film 70 may be omitted. When the nonmagnetic film 70 is omitted, the coating step S17 needs to be omitted in the method for manufacturing the inductor component 110 according to the second embodiment. Further, in the coating step S17, the nonmagnetic film 70 may be formed by applying the nonmagnetic film 70 over the entire outer face of the singulated portion 201 and by partially removing the nonmagnetic film 70 to expose the inductor wiring 30.

In the second embodiment, the configuration of the composite portion is not limited to the example of the second embodiment. For example, the nonmagnetic base material 82 may be alumina or an insulative thermoplastic resin such as an epoxy resin or an acrylic resin. Note that the composite portion 80 does not need to have a laminated structure like the magnetic thin strips 40 of the first portion P1 and the third portion P3 but may be an integrally molded body. In order to manufacture such composite portion 80, a range constituting the composite portion 80 needs to be filled with resin after the sintering step S16 and before the coating step S17, for example.

In the method of manufacturing the inductor component 110 according to the second embodiment, a sheet lamination method, in which multiple sheets are respectively formed and then laminated and pressure bonded, is exemplified. However, the method is not limited thereto. For example, a printing lamination method, in which multiple sheets are sequentially formed and laminated, may be used. In the case above, since the divided magnetic layer 212D is formed on the wiring pattern 221, the divided magnetic layer 212D is arranged above the wiring pattern 221.

In the method of manufacturing the inductor component 110 according to the second embodiment, the second sheet 220 may include the magnetic layer 212 or the nonmagnetic layer 211 or may include the magnetic layer 212 and the nonmagnetic layer 211, instead of the negative pattern 222. When the magnetic layer 212, the nonmagnetic layer 211, and the in-groove nonmagnetic portion 213 are provided instead of the negative pattern 222, the inductor component 10 according to the first embodiment may be manufactured. The negative pattern 222 needs to contain at least one of a magnetic material and a nonmagnetic material.

In the method of manufacturing the inductor component 110 according to the second embodiment, the singulation step S15 may be omitted. When the first sheet 210 and the second sheet 220 are prepared for only one singulated portion 201, the singulation step S15 needs to be omitted.

In the method of manufacturing the inductor component 110 described in the second embodiment, the portion corresponding to the first portion P1 or the third portion P3 includes the multiple magnetic thin strips 40 and interlayer nonmagnetic portions 50. Here, when the second sheet 220 is omitted, a laminated sheet in which the multiple first sheets 210 are laminated is formed. When the laminated sheet is sintered, a magnetic sheet in which the magnetic thin strip 40 is a sintered body may be manufactured. In the magnetic sheet, the multiple magnetic thin strips 40 are laminated in a direction along the second axis Z, that is, a direction along an orthogonal axis orthogonal to the main face MF of the magnetic thin strip 40. Further, two magnetic thin strips 40 are arranged side by side at the same position along the orthogonal axis in the direction along the first axis X, that is, in a direction along a first parallel axis parallel to the main face MF of the magnetic thin strip 40. Further, two magnetic thin strips 40 are arranged side by side at the same position along the orthogonal axis in the direction along the center axis CA, that is, a second parallel axis orthogonal to the orthogonal axis and the first parallel axis.

In each of the embodiments, the multiple magnetic thin strips 40 does not need to be regularly arranged. In particular, the multiple magnetic thin strips 40 may be partially irregularly arranged.

In each of the embodiments, a composite body may be mixed in the element body 20 in addition to the magnetic thin strip 40. For example, a composite body may be arranged at an outer side portion of the sintered singulated portion 201 by covering the sintered singulated portion 201 with the composite body containing a powdery magnetic material.

In each of the embodiments, the inductor component is described as an example of the electronic component. However, any electronic component, for example, a multilayer capacitor component is included. In the same manner, although the method for manufacturing an inductor component has been described as an example of the method for manufacturing an electronic component, any method for manufacturing an electronic component is included. In the case above, the wiring line does not need to be an inductor wiring and may be a flat plate-shaped wiring line such as a capacitor or may be a wiring line having another known shape.

In the element body described in Japanese Unexamined Patent Application Publication No. 2019-192920, characteristics as a magnetic material such as saturation magnetic flux density Bs are improved by increasing a filling rate of an inorganic filler. However, the technique described in Japanese Unexamined Patent Application Publication No. 2019-192920 is based on a structure in which particles of an inorganic filler are randomly dispersed, and structures of other magnetic materials are not studied at all.

Such magnetic sheet is suitable as a sheet, which transmits magnetic flux and is required to have an insulation property, for the element body 20 of the inductor component of each of the embodiments or the like. Further, with the use of such method for manufacturing a magnetic sheet, it is easy to efficiently manufacture a structure in which the magnetic thin strips 40 being sintered bodies are regularly arranged.

Technical ideas that may be taken from each of the embodiments and the modification will be additionally described below.

<Supplementary Note 1>

A magnetic sheet in which multiple flat plate-shaped magnetic thin strips made of a magnetic material of a sintered body, the multiple magnetic thin strips being laminated in a direction orthogonal to a main face of the magnetic thin strip, are included, and when “M” and “N” are positive integers, at least one of “M” and “N” is two or more, at each position in the lamination direction, the “M” magnetic thin strips are arranged side by side in a direction along a first reference axis, and the “N” magnetic thin strips are arranged side by side in a direction along a second reference axis.

<Supplementary Note 2>

A method of manufacturing a magnetic sheet, including forming a divided magnetic layer by forming a nonmagnetic layer using a nonmagnetic paste containing a nonmagnetic material, forming a magnetic layer on the nonmagnetic layer using a magnetic paste containing a magnetic material, dividing the magnetic layer by a groove, and filling the groove with a nonmagnetic paste containing a nonmagnetic material, forming a divided magnetic layer group by laminating the multiple divided magnetic layers, and firing the divided magnetic layer group to convert the nonmagnetic layer to an interlayer nonmagnetic portion of a sintered body, and to convert the magnetic layer to a magnetic thin strip of a sintered body.

What is claimed is:

1. An electronic component, comprising:
an element body including multiple flat plate-shaped magnetic thin strips including a magnetic material of a sintered body, the multiple magnetic thin strips being laminated in a lamination direction orthogonal to a main face of one of the magnetic thin strips; and
a wiring line extending along the main face inside the element body.

2. The electronic component according to claim 1, wherein
when “M” and “N” are positive integers, at least one of “M” and “N” is two or more, and the magnetic thin strip closest to the wiring line in the lamination direction among the multiple magnetic thin strips is a first magnetic thin strip,
at a same position as the first magnetic thin strip in the lamination direction, the “M” magnetic thin strips are side by side in a direction along a first reference axis orthogonal to the lamination direction, and the “N” magnetic thin strips are side by side in a direction along a second reference axis orthogonal to the lamination direction and the first reference axis.

3. The electronic component according to claim 2, wherein
at each position in the lamination direction, the “M” magnetic thin strips are side by side in the direction along the first reference axis, and the “N” magnetic thin strips are side by side in the direction along the second reference axis.

4. The electronic component according to claim 2, wherein
the element body includes a nonmagnetic portion including a nonmagnetic material of a sintered body between the magnetic thin strips adjacent to each other in the direction along the first reference axis, or between the magnetic thin strips adjacent to each other in the direction along the second reference axis.

5. The electronic component according to claim 1, wherein
the magnetic thin strip includes at least one of Fe, Ni, an alloy including an Fe element and an Si element, an alloy including the Fe element and an Ni element, and an alloy including the Fe element and a Co element.

6. The electronic component according to claim 1, wherein
in the magnetic thin strip, multiple magnetic metal particles are bonded via an insulative substance.

7. The electronic component according to claim 6, wherein
the insulative substance includes an O element.

8. The electronic component according to claim 6, wherein
the insulative substance includes an Si element.

9. The electronic component according to claim 6, wherein
the insulative substance includes a Cr element.

10. The electronic component according to claim 1, wherein
when an axis along which the wiring line extends is a center axis, an axis along the main face in a sectional view orthogonal to the center axis is a first axis, an axis orthogonal to the main face in the sectional view is a second axis, and one of two directions along the first axis is a first positive direction, and
in the sectional view,
an end of the wiring line in the first positive direction is a first wiring end,
the magnetic thin strip having a shortest distance from the first wiring end in a direction along the second axis among the magnetic thin strips laminated relative to the wiring line in the direction along the second axis is a second magnetic thin strip, and
a range excluding both ends of the second magnetic thin strip in a direction along the first axis is a first range, and
a virtual straight line passing through the first wiring end and extending in the direction along the second axis is drawn, the virtual straight line passes through the first range of the second magnetic thin strip.

11. The electronic component according to claim 10, wherein
a measurement of the second magnetic thin strip in the lamination direction is from 80% to 120% of an average value of measurements, in the lamination direction, of the multiple magnetic thin strips arranged in the lamination direction relative to the second magnetic thin strip.

12. The electronic component according to claim 1, wherein
the element body includes an interlayer nonmagnetic portion including a nonmagnetic material of a sintered body between the magnetic thin strips adjacent to each other in the lamination direction of the multiple magnetic thin strips.

13. The electronic component according to claim 12, wherein
the element body includes multiple interlayer nonmagnetic portions, each of which is the interlayer nonmagnetic portion, and
a measurement of one of the interlayer nonmagnetic portions in the lamination direction is from 80% to 120% of an average value of measurements of the multiple interlayer nonmagnetic portions in the lamination direction.

14. The electronic component according to claim 3, wherein
the element body includes a nonmagnetic portion including a nonmagnetic material of a sintered body between the magnetic thin strips adjacent to each other in the direction along the first reference axis, or between the magnetic thin strips adjacent to each other in the direction along the second reference axis.

15. A method of manufacturing an electronic component, comprising:
forming a divided magnetic layer by forming a nonmagnetic layer using a nonmagnetic paste including a nonmagnetic material, forming a magnetic layer on the nonmagnetic layer using a magnetic paste including a magnetic material, dividing the magnetic layer by a groove, and filling the groove with a nonmagnetic paste including a nonmagnetic material;
forming a multilayer body by arranging the divided magnetic layer above a wiring pattern formed with a conductive paste including a conductive material; and
firing the multilayer body to make the wiring pattern to a wiring line of a sintered body, to make the nonmagnetic layer to an interlayer nonmagnetic portion of a sintered body, and to make the magnetic layer to a magnetic thin strip of a sintered body.

16. The method of manufacturing an electronic component according to claim 15, further comprising:
preparing a first sheet by forming the divided magnetic layer into a sheet shape;
preparing a second sheet by forming the wiring pattern on a sheet-shaped base member; and
forming the multilayer body by pressure bonding the first sheet and the second sheet.

17. The method of manufacturing an electronic component according to claim 15, further comprising:
forming the multilayer body by forming the divided magnetic layer on the wiring pattern.

18. The method of manufacturing an electronic component according to claim 15, further comprising:
forming a negative pattern by forming the wiring pattern on a base member and filling a negative paste including at least one of a magnetic material and a nonmagnetic material on the base member on which the wiring pattern is not formed.

19. The method of manufacturing an electronic component according to claim 15, further comprising:
laminating multiple divided magnetic layers, each of which is the divided magnetic layer, when the multilayer body is formed.

20. The method of manufacturing an electronic component according to claim 15, further comprising:
arranging multiple singulated portions constituted of the wiring pattern and the divided magnetic layer in a matrix when the multilayer body is formed; and
dividing the multilayer body into the singulated portions.
